(19) United States
(12) Patent Application Publication
(10) Pub. No.: US 2006/0177802 A1
(43) Pub. Date: Aug. 10, 2006

(54) Audio conversation device, method, and robot device

(76) Inventors: Atsuo Hiroe, Kanagawa (JP); Hideki Shimomura, Kanagawa (JP); Helmut Lucke, Tokyo (JP); Katsuki Minamino, Tokyo (JP); Haru Kato, Tokyo (JP)

Correspondence Address: William S Frommer;Frommer Lawrence & Haug, 745 Fifth Avenue, New York, NY, 10151, US

(21) Appl. No.: 10/549,795

(22) PCT Filed: Mar. 16, 2004
(86) PCT No.: PCT/JP04/03502

§ 371 Date: Sep. 19, 2005

(30) Foreign Application Priority Data
Mar. 20, 2003 (JP) 2003-078086

(51) Int. Cl. G09B 19/04

(52) U.S. Cl. 434/185

(57) ABSTRACT

In a conventional voice dialogue system, there is a case where it is difficult to perform a natural dialogue with the user. Therefore, we designed to perform speech recognition on the user's utterance, to control a dialogue with the user according to a scenario previously given, based on the speech recognition result to generate an answering sentence corresponding to the contents of the user's utterance as the occasion demands, and to perform voice synthesis processing to one sentence in the reproduced scenario or the generated answering sentence.

### TECHNICAL FIELD

The present invention relates to a system and a method of voice dialogue and a robot apparatus, and is suitable to entertainment robots, for example.

### BACKGROUND ART

Dialogues performed by voice dialogue systems with human beings by voice are classified into two types of methods depending on the contents. They are “dialogue having no scenario” and “dialogue having scenario”.

Among them, the “dialogue having no scenario” method is a dialogue method called “artificial unintelligence”, which is realized by a simple answering sentence generation algorithm typified by the Eliza (see non-patent document 1).

In the “dialogue having no scenario” method, as shown in FIG. 36, the processing is performed by repeating a repeat of the procedure (step SP92) that if the user utters some words, the voice dialogue system performs speech recognition on it (step SP90), and generates an answering sentence according to the recognition result and emits this by sound (step SP91).

A problem in this “dialogue having no scenario” method is that dialogue does not progress if the user does not utter. For example, if a response generated in step SP91 in FIG. 36 is the contents urging the user to the next utterance, the dialogue progresses, however, if it is not, for example, if the user becomes into the state “cannot say the next word”, the voice dialogue system continues to await the user's utterance and the dialogue does not progress.

Furthermore, in the “dialogue having no scenario” method, the dialogue does not have scenario, so that also there is a problem that it is difficult to generate an answering sentence considered in a flow of dialogue at the time of generating a response in step SP91 in FIG. 36. For instance, it is difficult to perform the processing that after having heard the user's profile over, the voice dialogue system makes it reflect in the dialogue.

On the other hand, the “dialogue having scenario” is a dialogue method in which the dialogue is progressed by that the voice dialogue system sequentially utters according to a predetermined scenario, and it is progressed by the combination of the turn in which the voice dialogue system one-sidedly utters, and the turn in which the voice dialogue system questions the user and further responds to the user's answer to the question. Note that, “turn” means an utterance that is clearly independent in a dialogue or one unit of a dialogue.

In the case of this dialogue method, the user is good only to answer to the question, so that the user does not lose what he/she utters. Furthermore, the user's utterance can be limited by the contents of questions, so that the design of answering sentence is comparatively easy in the turn that the voice dialogue system further responds according to the user's answer. For example, as a question from the voice dialogue system to the user in this turn, it is good to prepare only two types for “yes” and “no”. Additionally, also there is an advantage that the voice dialogue system can generate an answering sentence by using a flow of story.

Patent Document 1 “Artificial Unintelligence Review”, [on line], [searched on Mar. 14, 2003 (Heisei 15)], Internet <URL: http://www.ycf.nanet.co.jp/-skato/muno/review.htm>

However, also this dialogue method has problems. First, it is that since the voice dialogue system can only give utterance according to the scenario previously designed by assuming the contents of the user's answer, the voice dialogue system cannot respond when the user uttered unexpected words.

For example, to the question that can be answered by “yes/no”, if the user replied that both of them are okay, he have never thought about such a thing, or the like, the voice dialogue system cannot make any response, or even if it responds, it can be only extremely unsuitable response as a response to the user's answer. Furthermore, in such case, the possibility that after that, the story becomes unnatural is high.

Secondly, it is that the setting of the degree of the appearance ratio of the turn in which the voice dialogue system one-sidedly utters to the turn in which the voice dialogue system questions the user and further responds according to the user's answer to the question, is difficult.

Practically, in the above voice dialogue system, if the former turn is too frequent, it gives an impression that the voice dialogue system is one-sidedly uttering to the user, and the user does not feel “making a dialogue”. Conversely, if the latter turn is too frequent, it gives a feeling that the user is answering a questionnaire or inquisition to the user; also in this case, the user does not feel “making a dialogue.”

Accordingly, it can be considered that by solving such problems in the conventional voice dialogue systems, a voice dialogue system can make natural dialogue with the user, and its practicability and entertainment ability can be remarkably improved.

### DESCRIPTION OF THE INVENTION

The present invention has been done considering the above points, and provides a voice dialogue system, a voice dialogue method and a robot apparatus that can perform a natural dialogue with the user.

To solve the above problems, according to the present invention, in the voice dialogue system, dialogue control means for controlling a dialogue with the user according to a scenario previously given, based on a speech recognition result by speech recognition means for performing speech recognition on the user's utterance, and response generating means for generating an answering sentence corresponding to the contents of the user's utterance, responding to a request from the dialogue control means are provided. The dialogue control means makes a request to the response generating means to generate an answering sentence as the occasion demands, based on the contents of the user's utterance.

Consequently, in this voice dialogue system, it can be prevented that a dialogue with the user becomes unnatural, and also a feeling of “making a dialogue” can be given to the above user.

Furthermore, according to the present invention, a first step for performing speech recognition on the user's utterance, a second step for controlling a dialogue with the user according to a scenario previously given, based on the speech recognition result, and if needed, generating an answering sentence corresponding to the contents of the user's utterance, and a third step for performing speech synthesis processing to one sentence in the reproduced scenario or the generated answering sentence are provided. In the second step, an answering sentence corresponding to the contents of the user's utterance is generated as the occasion demands, based on the contents of the user's utterance.

Consequently, by this voice dialogue method, it can be prevented that a dialogue with the user becomes unnatural, and also a feeling of “making a dialogue” can be given to the above user.

Furthermore, according to the present invention, in the robot apparatus, dialogue control means for controlling a dialogue with the user according to a scenario previously given, based on a speech recognition result by speech recognition means for performing speech recognition on the user's utterance, and response generating means for generating an answering sentence corresponding to the contents of the user's utterance, responding to a request from the dialogue control means are provided. The dialogue control means makes a request to the response generating means to generate an answering sentence as the occasion demands, based on the contents of the user's utterance.

Consequently, in this robot apparatus, it can be prevented that a dialogue with the user becomes unnatural, and also a feeling of “making a dialogue” can be given to the above user.

### BRIEF DESCRIPTION OF THE DRAWINGS

FIG. 1 is a perspective view showing the external structure of a robot according to this embodiment.

FIG. 2 is a perspective view showing the external structure of the robot according to this embodiment.

FIG. 3 is a conceptual view for explaining the external structure of the robot according to this embodiment.

FIG. 4 is a conceptual view for explaining the internal structure of the robot according to this embodiment.

FIG. 5 is a block diagram for explaining the internal structure of the robot according to this embodiment.

FIG. 6 is a block diagram for explaining the contents of processing by a main control part relating to dialogue control.

FIG. 7 is a conceptual view for explaining the structure of a scenario.

FIG. 8 is a schematic diagram showing the script format of each block.

FIG. 9 is a schematic diagram showing an example of the program structure of a one-sentence scenario block.

FIG. 10 is a flowchart showing the procedure for reproducing one-sentence scenario block.

FIG. 11 is a schematic diagram showing an example of the program structure of a question block.

FIG. 12 is a flowchart showing the procedure for reproducing question block.

FIG. 13 is a schematic diagram showing an example of a semantics definition file.

FIG. 14 is a schematic diagram showing an example of the program structure of a first question/answer block.

FIG. 15 is a flowchart showing the procedure for reproducing first question/answer block.

FIG. 16 is a schematic diagram showing types of tags to be used in a response generating part.

FIG. 17 is a schematic diagram showing an example of an answering sentence generating rule file.

FIG. 18 is a schematic diagram showing an example of the answering sentence generating rule file.

FIG. 19 is a schematic diagram showing an example of the answering sentence generating rule file.

FIG. 20 is a schematic diagram showing an example of the answering sentence generating rule file.

FIG. 21 is a schematic diagram showing an example of the answering sentence generating rule file.

FIG. 22 is a schematic diagram showing an example of a rule table.

FIG. 23 is a schematic diagram showing an example of the program structure of a second question/answer block.

FIG. 24 is a flowchart showing the procedure for reproducing second question/answer block.

FIG. 25 is a schematic diagram showing an example of the program structure of a third question/answer block.

FIG. 26 is a flowchart showing the procedure for reproducing third question/answer block.

FIG. 27 is a schematic diagram showing an example of the program structure of a fourth question/answer block.

FIG. 28 is a flowchart showing the procedure for reproducing fourth question/answer block.

FIG. 29 is a schematic diagram showing an example of the program structure of a first dialogue block.

FIG. 30 is a schematic diagram showing an example of the program structure of the first dialogue block.

FIG. 31 is a flowchart showing the procedure for reproducing first dialogue block.

FIG. 32 is a conceptual view showing the list of insertion prompts.

FIG. 33 is a schematic diagram showing an example of the program structure of a second dialogue block.

FIG. 34 is a schematic diagram showing an example of the program structure of the second dialogue block.

FIG. 35 is a flowchart showing the procedure for reproducing second dialogue block.

FIG. 36 is a flowchart for explaining a dialogue system by artificial unintelligence.

### BEST MODE FOR CARRYING OUT THE INVENTION

An embodiment of the present invention will be described in detail with reference to the accompanying drawings.

(1) General Structure of Robot According to this Embodiment

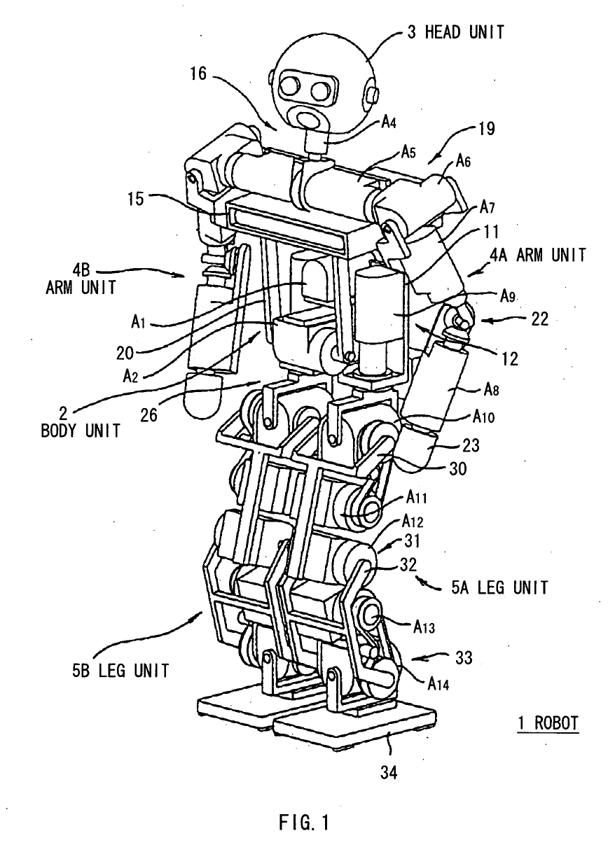

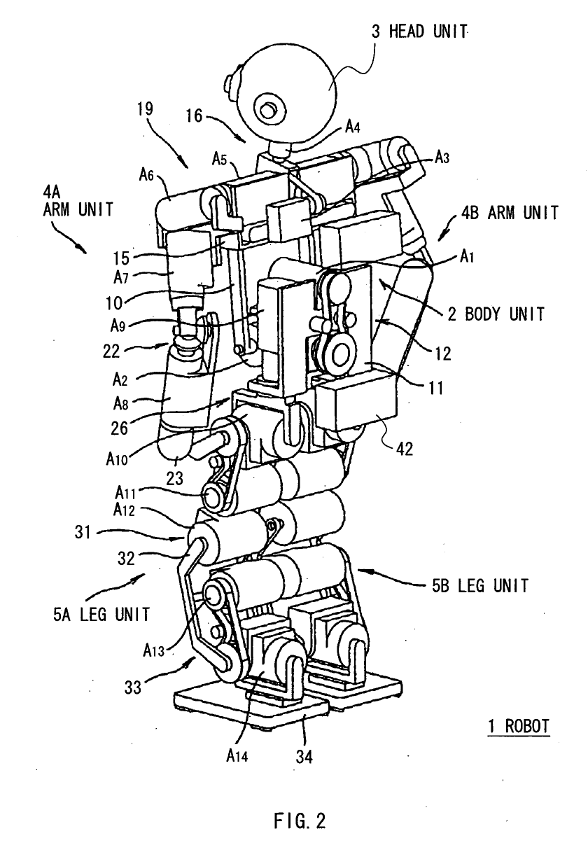

Referring to FIGS. 1 and 2, reference numeral 1 generally shows a bipedal robot according to this embodiment. A head unit 3 is disposed on a body unit 2, arm units 4A and 4B having the same structure are disposed on the upper left part and the upper right upper part of the above body unit 2 respectively, and leg units 5A and 5B having the same structure are attached to predetermined positions on the left lower part and the right lower part of the body unit 2 respectively.

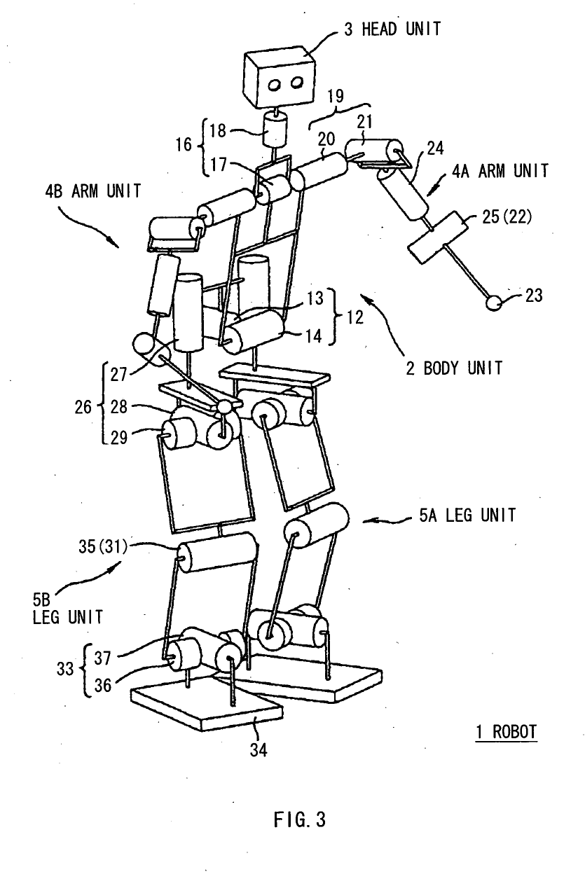

In the body unit 2, a frame 10 forming the upper part of a torso and a waist base 11 forming the lower part of the torso are connected via a waist joint mechanism 12. The actuators A₁ and A₂ of the waist joint mechanism 12 fixed to the waist base 11 forming the lower part of the torso are respectively driven, so that the upper part of the torso can be turned according to the respectively independent turn of a roll shaft 13 and a pitch shaft 14 that are orthogonal, shown in FIG. 3.

The head unit 3 is attached to the top center part of a shoulder base 15 fixed to the upper ends of a frame 10 via a neck joint mechanism 16. The actuators A₃ and A₄ of the above neck joint mechanism 16 are respectively driven, so that the head unit 3 can be turned according to the respectively independent turn of a pitch shaft 17 and a yaw shaft 18 that are orthogonal, shown in FIG. 3.

The arm units 4A and 4B are attached to the left end and the right end of the shoulder base 15 via a shoulder joint mechanism 19 respectively. The actuators A₅ and A₆ of the corresponding shoulder joint mechanism 19 are respectively driven, so that the arm units 4A and 4B can be turned respectively independently, according to the turn of a pitch shaft 20 and a roll shaft 21 that are orthogonal, shown in FIG. 3.

In this case, in each of the arm units 4A and 4B, an actuator A₈ forming a forearm part is connected to the output shaft of an actuator A₇ forming an upper arm part via an arm joint mechanism 22. A hand part 23 is attached to the end of the above forearm part.

In the arm units 4A and 4B, the forearm parts can be turned according to the turn of yaw shafts 24 shown in FIG. 3 by driving the actuator A₇, and the forearm parts can be turned according to the turn of pitch shafts 25 shown in FIG. 3 by driving the actuator A₈.

On the other hand, the leg units 5A and 5B are attached to the waist base 11 forming the lower part of the torso via a hip joint mechanism 26 respectively. The actuators A₉ to A₁₁ of the corresponding hip joint mechanism 26 are driven respectively, so that the hip joint mechanisms 26 can be turned respectively independently, according to the turn of a yaw shaft 27, a roll shaft 28 and a pitch shaft 29 that are mutually orthogonal, shown in FIG. 3.

In this case, in each of the leg units 5A and 5B, a frame 32 forming an underthigh part is connected to the lower end of the frame 30 forming a thigh part via a knee joint mechanism 31, and a foot part 34 is connected to the lower end of the above frame 32 via an ankle joint mechanism 33.

Thereby, in the leg units 5A and 5B, the underthigh parts can be turned according to the turn of pitch shafts 35 shown in FIG. 3 by driving actuators A₁₂ forming the knee joint mechanisms 31. Furthermore, the foot parts 34 can be turned respectively independently, according to the turn of a pitch shaft 36 and a roll shaft 37 that are orthogonal, shown in FIG. 3, by respectively driving the actuators A₁₃ and A₁₄ of the ankle joint mechanism 33.

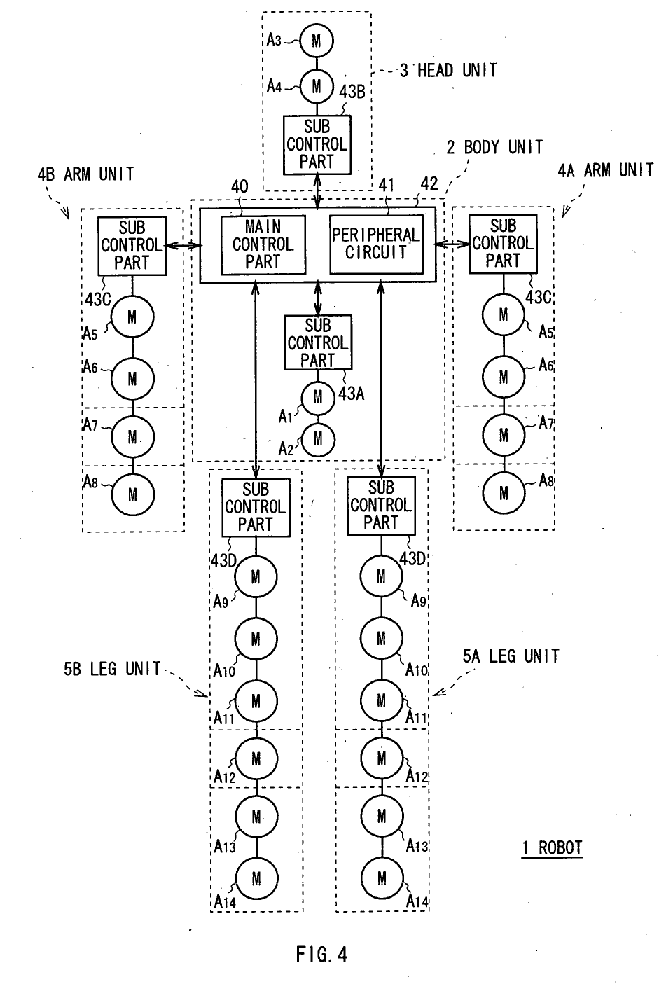

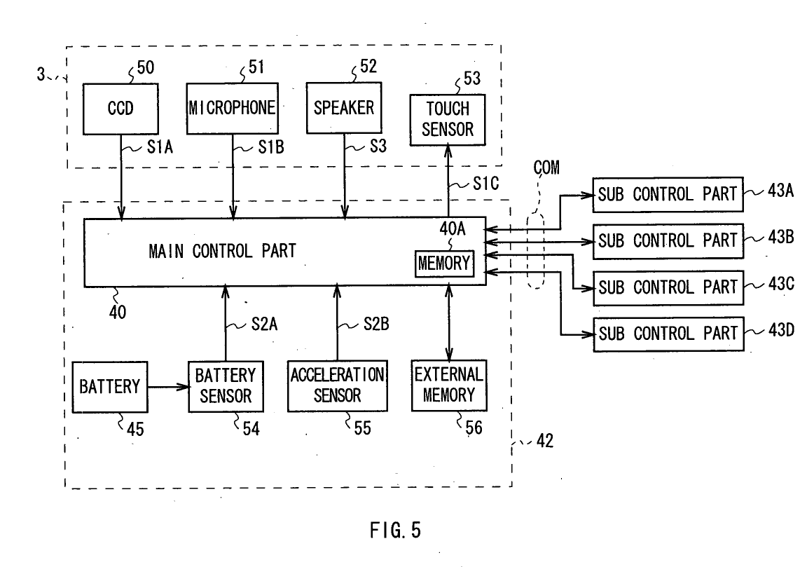

On the back side of the waist base 11 forming the lower part of the torso of the body unit 2, as shown in FIG. 4, a control unit 42 in which a main control part 40 for controlling the entire movements of the above robot 1, a peripheral circuit 41 such as a power supply circuit and a communication circuit, a battery 45 (FIG. 5), etc. are contained in a box, is disposed.

This control unit 42 is connected to each of sub control parts 43A to 43D respectively disposed in the forming units (the body unit 2, head unit 3, arm units 4A and 4B, and leg units 5A and 5B). Thereby, a necessary power supply voltage can be supplied to these sub control parts 43A to 43D, and the control unit 42 can perform communication with these sub control parts 43A to 43D.

Each of the sub control parts 43A to 43D is connected to the actuators A₁ to A₁₄ in the respectively corresponding forming unit, so that each of the actuators A₁ to A₁₄ in the above forming units can be driven into a state where it was specified based on various control commands given from the main control part 40, respectively.

In the head unit 3, as shown in FIG. 5, various external sensors such as a charge coupled device (CCD) camera 50 having a function as “eye” of this robot 1, a microphone 51 having a function as “ear”, and a speaker 52 having a function as “mouse”, are disposed on respective predetermined positions. Touch sensors 53 are disposed on the hand parts 23 and the foot parts 34 as external sensors. Furthermore, in the control unit 42, internal sensors such as a battery sensor 54 and an acceleration sensor 55 are contained.

The CCD camera 50 picks up the images of surroundings, and transmits thus obtained video signal S1A to the main control part 40. The microphone 51 picks up various external sounds, and transmits thus obtained audio signal S1B to the main control part 40. And each of the touch sensors 53 detects a physical touch on an external object, and transmits the detection results to the main control part 40 as a pressure detecting signal S1C.

The battery sensor 54 detects the remaining quantity of the battery 45 in a predetermined cycle, and transmits the detection result to the main control part 40 as a remaining battery detecting signal S2A. And the acceleration sensor 55 detects acceleration in the three axis directions (x-axis, y-axis and z-axis) in a predetermined cycle, and transmits the detection result to the main control part 40 as an acceleration detecting signal S2B.

The main control part 40 has the configuration of a microcomputer having a central processing unit (CPU), an internal memory 40A serving as a read only memory (ROM) and a random access memory (RAM), etc. The main control part 40 determines the surrounding state and the internal state of the robot 1, by whether an external object touched or not, or the like, based on external sensor signals S1 such as the video signal S1A, the audio signal S1B and the pressure detecting signal S1C that are respectively supplied from each external sensor such as the CCD camera 50, the microphone 51 and the touch sensors 53, and internal sensor signals S2 such as the remaining battery detecting signal S2A and the acceleration detecting signal S2B that are respectively supplied from each internal sensor such as the battery sensor 54 and the acceleration sensor 55.

Then, the main control part 40 determines the next movement based on this determination result, a control program previously stored in the internal memory 40A, and various control parameters stored in an external memory 56 being loaded at the time, and transmits a control command based on the determination result to the corresponding sub control part 43A-43D. As a result, the corresponding actuator A₁-A₁₄ is driven based on this control command, under the control of that sub control part 43A-43D. Thus, movements such as swinging the head unit 3 in all directions, raising the arm units 4A and 4B, and walking are appeared by the robot 1.

The main control part 40 recognizes the contents of the user's utterance by predetermined speech recognition processing to the above audio signal S1B supplied from the microphone 51, and supplies an audio signal S3 according to the above recognition to the speaker 52. Thereby, a synthetic voice to perform a dialogue with the user is emitted to the outside.

In this manner, this robot 1 can move autonomously based on the surrounding state and the internal state, and also can make a dialogue with the user.

(2) Processing by Main Control Part 40 Relating to Dialogue Control

(2-1) Contents of Processing by Main Control Part 40 Relating to Dialogue Control

Next, the contents of processing by the main control part 40 relating to dialogue control will be described.

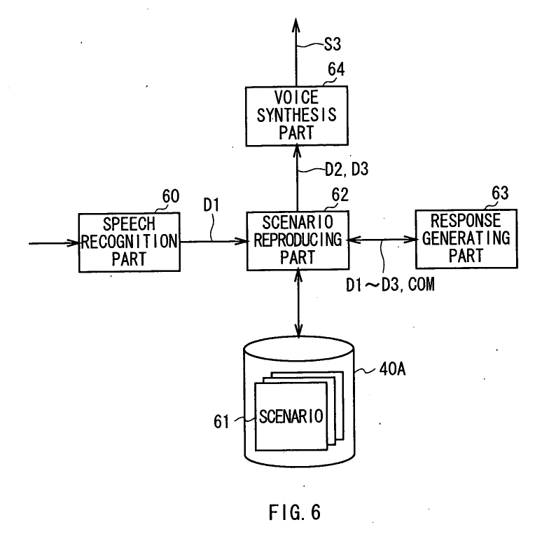

If classifying the contents of processing by the main control part 40 relating to dialogue control in this robot 1 by function, as shown in FIG. 6, they can be classified into a speech recognition part 60 for performing voice recognition to the voice uttered by the user, a scenario reproducing part 62 for controlling a dialogue with the user based on the recognition result by the above speech recognition part 60, according to a scenario 61 previously given, a response generating part 63 for generating an answering sentence responding to a request from the scenario reproducing part 62, and a voice synthesis part 64 for generating a synthetic voice of one sentence of the scenario 61 reproduced by the scenario reproducing part 62 or the answering sentence generated by the response generating part 63. Note that, in the description below, it is defined that “one sentence” means one unit paused in utterance: this “one sentence” may not be always “a piece of sentence”.

Here, the speech recognition part 60 has the function to execute predetermined speech recognition processing based on the audio signal S1B supplied from the microphone 51 (FIG. 5) and recognize the speech included in the above audio signal S1B in word unit. The speech recognition part 60 supplies these recognized words to the scenario reproducing part 62 as character string data D1.

The scenario reproducing part 62 manages speech (prompt) that has been previously given by being stored in the external memory 56 (FIG. 5), and should be uttered by the above robot 1 in the process of a series of dialogue with the user, by reading data for plural scenarios 61 provided over plural turns from the above external memory 56 to the internal memory 40A.

In a dialogue with the user, in these plural scenarios 61, the scenario reproducing part 62 selects a scenario 61 suited to the user who was recognized and identified by a face recognition part not shown based on the picture signal S1A supplied from the CCD camera 50 (FIG. 5), and becomes the other party of the dialogue, and reproduces the scenario 61. Thereby, character string data D2 corresponding to the voice uttered by the robot 1 is sequentially supplied to the voice synthesis part 64.

Furthermore, if the scenario reproducing part 62 confirms that the user gave unexpected utterance as an answer to the question that the robot 1 asked, based on the character string data D1 supplied from the speech recognition part 60, the scenario reproducing part 62 supplies the above character string data D1 and an answering sentence generation request COM to the response generating part 63.

The response generating part 63 is formed by an artificial unintelligence module for generating an answering sentence by simple answering sentence generation algorithm such as the Eliza engine. If the answering sentence generation request COM is supplied from the scenario reproducing part 62, the response generating part 63 generates an answering sentence according to the character string data D1 that was supplied together with the answering sentence generation request COM, and supplies its character string data D3 to the voice synthesis part 64 via the scenario reproducing part 62.

The voice synthesis part 64 generates synthetic voice based on the character string data D2 supplied from the scenario reproducing part 62 or the character string data D3 supplied from the response generating part 63 via the above scenario reproducing part 62, and supplies thus obtained audio signal S3 of the above synthetic voice to the speaker 52 (FIG. 5). Therefore, the synthetic voice based on this audio signal S3 is emitted from the speaker 52.

In this manner, in this robot 1, utterance by a combination of “dialogue having no scenario” and “dialogue having scenario” can be performed. Thereby, for example, even if the user replied unexpected words to the question by the robot 1, the robot 1 can suitably respond to this.

(2-2) Configuration of Scenario 61

(2-2-1) General Configuration of Scenario 61

Next, the configuration of the scenario 61 in this robot 1 will be described.

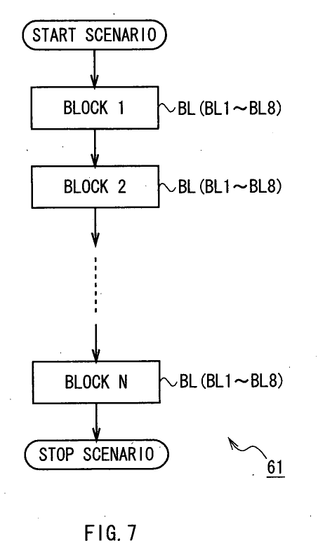

In the case of this robot 1, as shown in FIG. 7, each scenario 61 is formed by arraying an arbitrary number of plural kinds of blocks BL (BL1-BL8) providing an action of the robot 1 for one turn in a dialogue including one sentence that should be uttered by the robot 1, in arbitrary order.

Here, in the case of this robot 1, as the above program providing an action for one turn including the contents of utterance of the robot 1 in a dialogue with the user (hereinafter, this is referred to as block BL (BL1-BL8)), there are eight types of blocks BL1-BL8. Next, the configuration of each of these eight types of blocks BL1-BL8 and reproducing procedure of each of these eight types of blocks BL1-BL8 by the scenario reproducing part 62 will be described.

Note that, “one sentence scenario block BL1” and “question block BL2” which will be described next exist already, and each block BL3-BL8 which will be described following them does not exist ever and is peculiar to this robot 1.

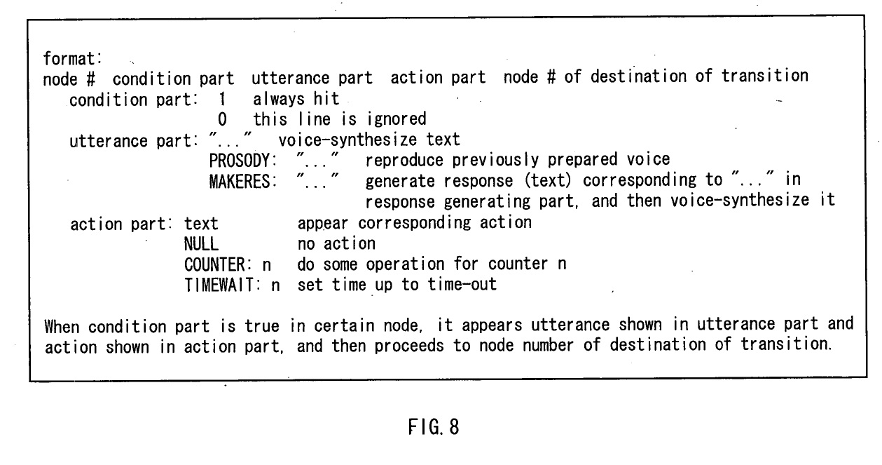

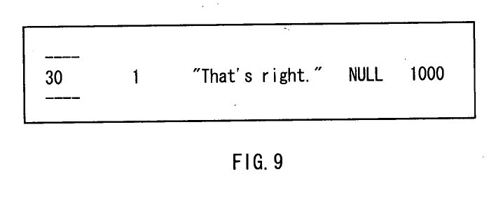

Furthermore, in the following FIGS. 9, 11, 14, 23, 25, 27, 29, 30, 33 and 34, each script (program configuration) will be described according to the rule shown in FIG. 8. In the reproducing processing of each block BL, the scenario reproducing part 62 supplies character string data D2 to the voice synthesis part 64 and gives an answering sentence generation request to the response generating part 63, according to this rule.

(2-2-2) One Sentence Scenario Block BL1

The one sentence scenario block BL1 is a block BL composed of only one sentence in the scenario 61, and for example it has a program configuration shown in FIG. 9.

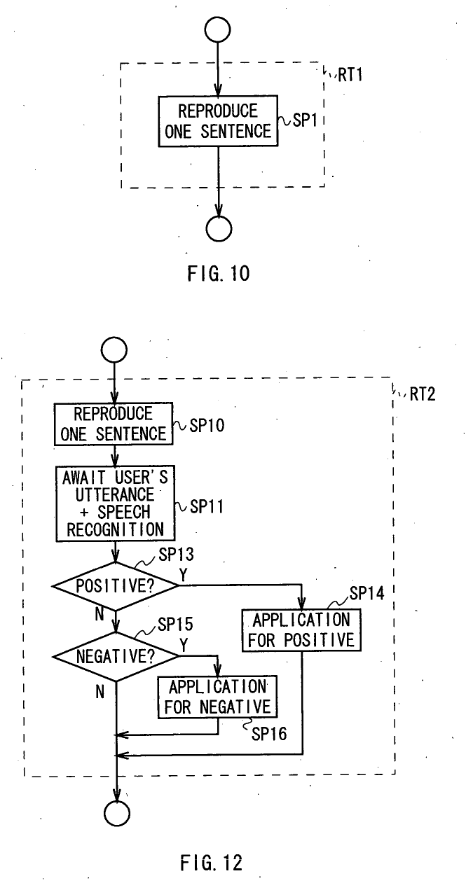

When in reproducing the one sentence scenario block BL1, according to a procedure for reproducing one sentence scenario block RT1 shown in FIG. 10, in step SP1, the scenario reproducing part 62 reproduces one sentence provided by the block maker, and supplies its character string data D2 to the voice synthesis part 64. Then, the scenario reproducing part 62 stops the reproducing processing of this one sentence scenario block BL1, and then proceeds to the reproducing processing of a block BL following this.

(2-2-3) Question Block BL2

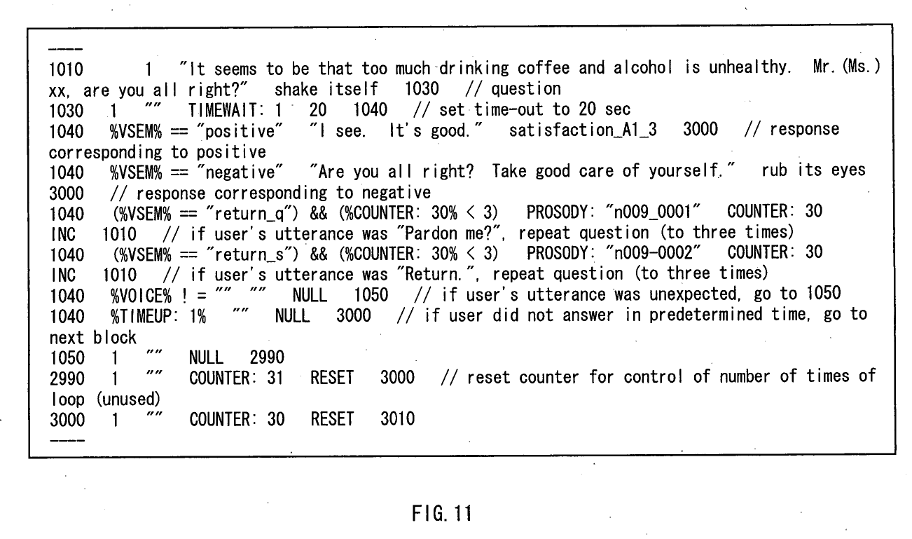

The question block BL2 is a block BL that will be used in the case of asking the user a question or the like, and for example it has a program configuration shown in FIG. 11. In this question block BL2, it urges the user to utterance, and the robot 1 utters a prompt for positive or negative provided by the block maker, according to whether or not the user's answer to the question was positive.

Practically, when in reproducing this question block BL2, according to a procedure for reproducing question block RT2 shown in FIG. 12, first, in step SP10, the scenario reproducing part 62 reproduces one sentence provided by the block maker and supplies its character string data D2 to the voice synthesis part 64. And then, in the next step SP11, the scenario reproducing part 62 awaits the user's answer (utterance) to this.

If soon recognizing that the user replied based on the character string data D1 from the speech recognition part 60, the scenario reproducing part 62 proceeds to step SP12 to determine whether or not the contents of that answer was positive.

If a positive result is obtained in this step SP12, the scenario reproducing part 62 proceeds to step SP13 to reproduce an answering sentence for positive and supplies its character string data D2 to the voice synthesis part 64, and stops the reproducing processing of this question block BL2. Then, the scenario reproducing part 62 proceeds to the reproducing processing of a block BL following this.

On the contrary, if a negative result is obtained in step SP12, the scenario reproducing part 62 proceeds to step SP14 to determine whether or not the user's answer that was recognized in step SP11 was negative.

If an affirmative result is obtained in this step SP14, the scenario reproducing part 62 proceeds to step SP15 to reproduce an answering sentence for negative and supplies its character string data D2 to the voice synthesis part 64, and then stops the reproducing processing of this question block BL2. Then, the scenario reproducing part 62 proceeds to the reproducing processing of a block BL following this.

On the contrary, if a negative result is obtained in step SP14, the scenario reproducing part 62 stops the reproducing processing of this question block BL2 as it is. Then, the scenario reproducing part 62 proceeds to the reproducing processing of a block BL following this.

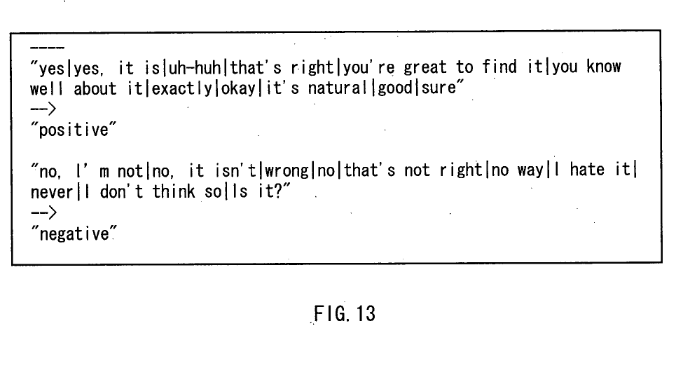

Note that, in the case of this robot 1, as the means for determining whether the user's response was positive or negative, the scenario reproducing part 62 has a semantics definition file shown in FIG. 13, for example.

The scenario reproducing part 62 determines whether the user's answer was positive (“positive”) or negative (“negative”) by referring to this semantics definition file, based on the character string data D1 supplied from the speech recognition part 60.

(2-2-4) First Question/Answer Block BL3 (No Loop)

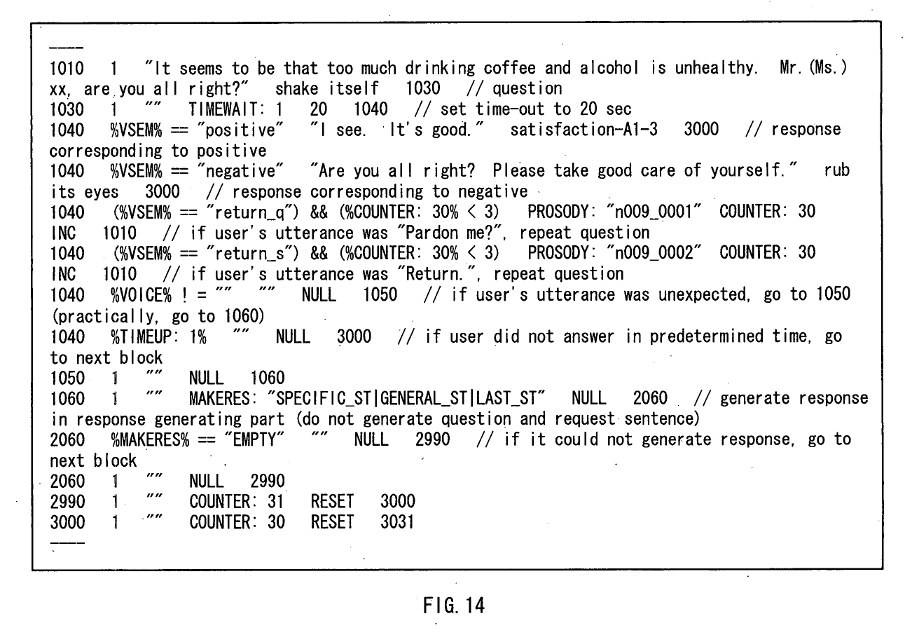

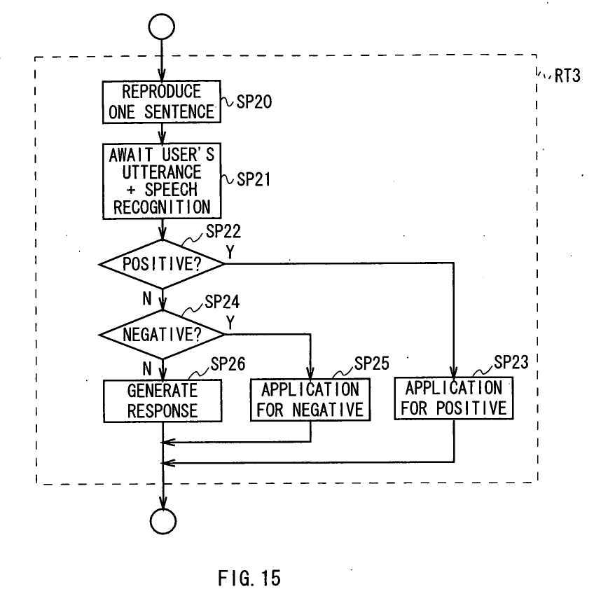

The first question/answer block BL3 is a block BL that will be used in the case of asking the user a question or the like similarly to the aforementioned question block BL2, and has a program configuration shown in FIG. 14, for example. This first question/answer block BL3 is designed so that even if the user's answer to a question or the like was neither positive nor negative, the robot 1 can respond.

Practically, when in reproducing this first question/answer block BL3, according to a procedure for reproducing first question/answer block shown in FIG. 15, first, as to steps SP20-SP25, the scenario reproducing part 62 performs processing similarly to steps SP10-SP14 of the aforementioned procedure for reproducing question block RT2 (FIG. 12).

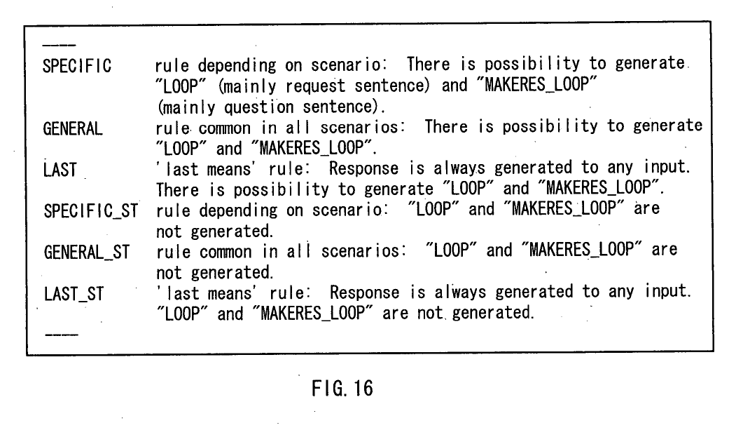

If a negative result is obtained in step SP24, the scenario reproducing part 62 supplies an answering sentence generation request COM and a tag denoting a kind of a rule to generate an answering sentence to be generated (SPECIFIC, GENERAL, LAST, SPECIFIC ST, GENERAL ST, LAST) for example shown in FIG. 16, to the response generating part 63 (FIG. 6), with the character string data D1 that was supplied from the speech recognition part 60 at that time. Note that, the tag which will be supplied to the response generating part 63 by the scenario reproducing part 62 at this time has already been determined by the block maker (for example, see the line of node number “1060” in FIG. 14).

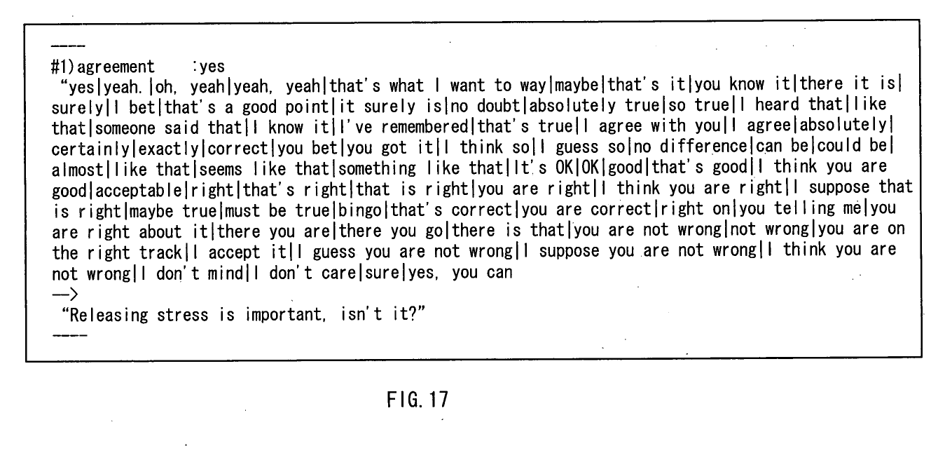

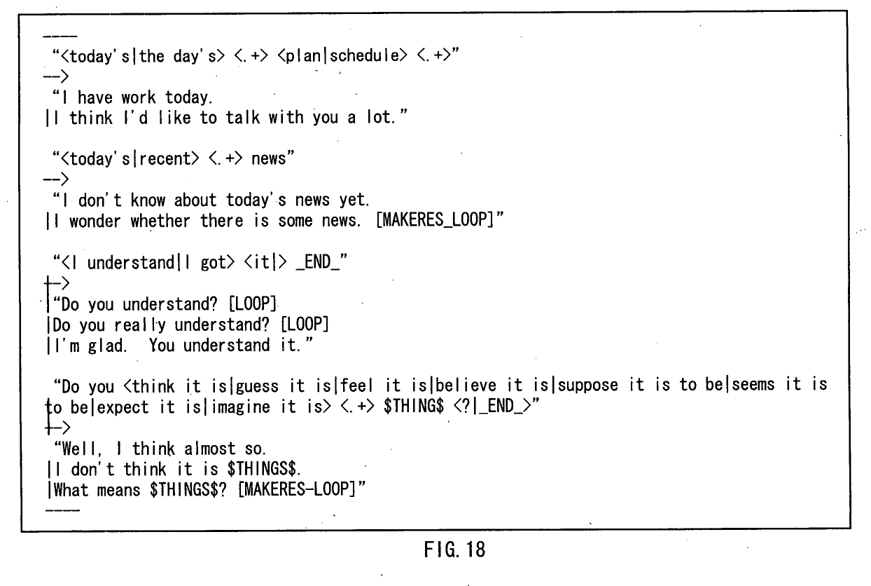

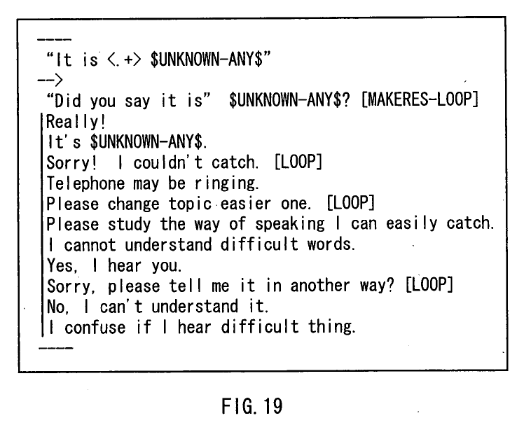

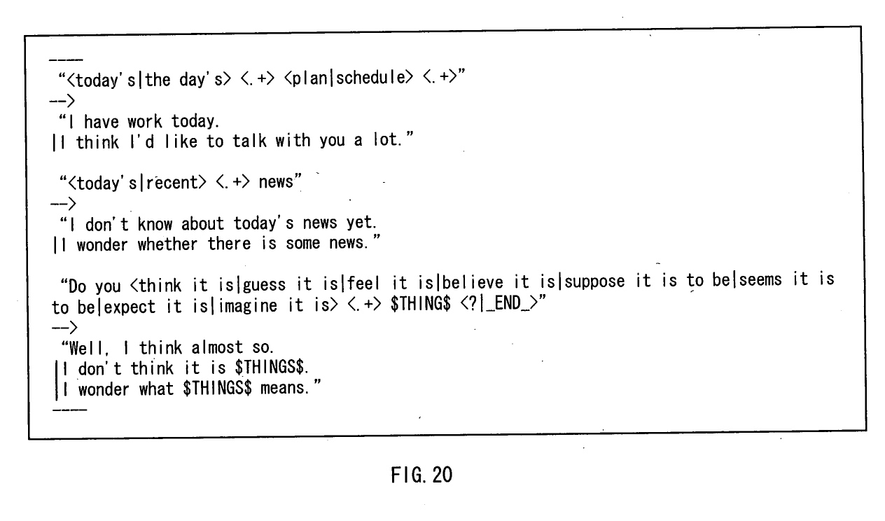

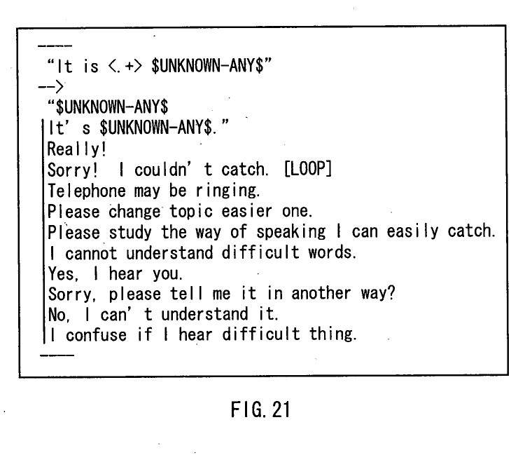

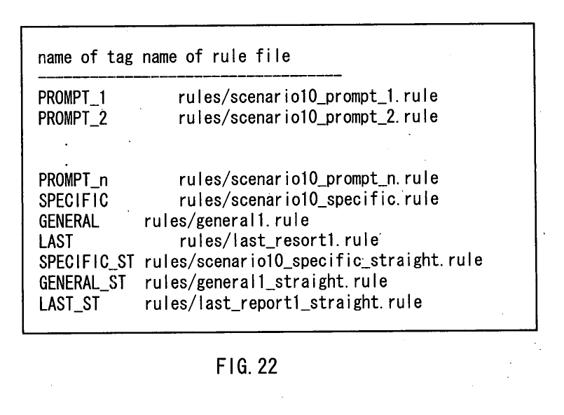

At this time, the response generating part 63 has plural files in which the generation rule of a corresponding answering sentence has been provided, for example shown in FIGS. 17-21, by respectively corresponding to each kind of the generation rules of an answering sentence to be generated. Furthermore, the response generating part 63 has a rule table shown in FIG. 22, in which these files have been related to the tags to be supplied from the scenario reproducing part 62.

In this manner, the response generating part 63 refers to this rule table, based on the file, the tag supplied from the scenario reproducing part 62 and the character string data D1 supplied from the speech recognition part 60 at that time, generates an answering sentence according to the corresponding generation rule of an answering sentence, and supplies its character string data D3 to the voice synthesis part 64 via the scenario reproducing part 62.

Then, the scenario reproducing part 62 stops the reproducing processing of this first question/answer block BL3, and proceeds to the reproducing processing of a block BL following this.

(2-2-5) Second Question/Answer Block BL4 (Loop Type 1)

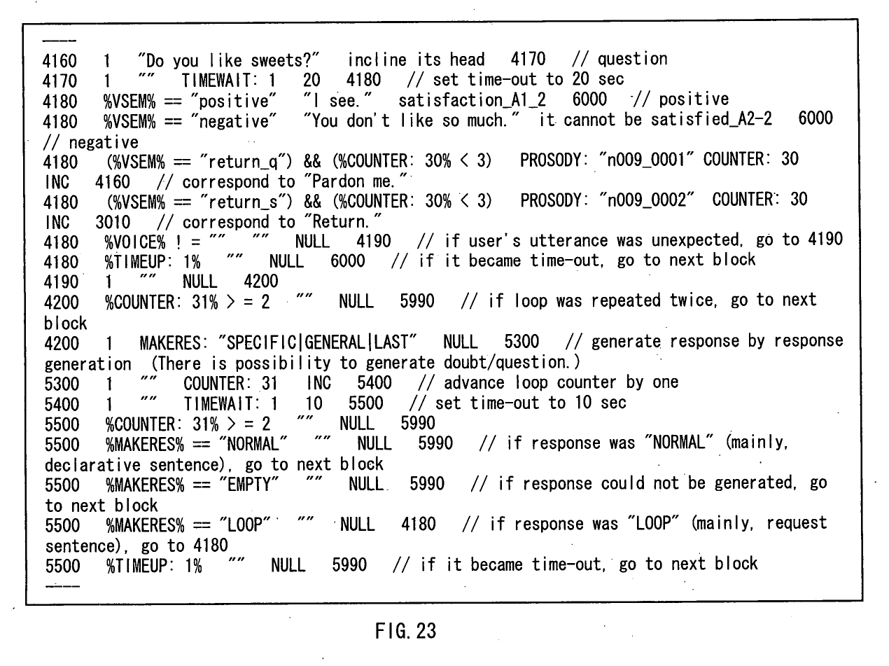

The second question/answer block BL4 is a block BL that will be used in the case of asking the user a question or the like similarly to the question block BL2, and it has a program configuration shown in FIG. 23, for example. This second question/answer block BL4 will be used to prevent that a dialogue becomes unnatural, by considering the contents of an answering sentence to be generated in the response generating part 63 in the case where the user's answer to the question or the like was neither positive nor negative.

Concretely, for example, in step SP26 of the procedure for reproducing first question/answer block RT3 described above with FIG. 15, in the case where the response generating part 63 generated a request sentence such as “Try to say the same thing in different words.” or a question sentence such as “Is that true?”, if the scenario reproducing part 62 proceeds to the reproducing processing of the next block BL after it finished the processing of step SP26, the user cannot answer the request or question, so that the dialogue becomes unnatural.

Therefore, in this second question/answer block BL4, it is designed so that when the response generating part 63 generates an answering sentence, in the case where there is a possibility to generate a question sentence which can be responded by the user by “yes” or “no” as the above answering sentence, the user's response to this can be accepted.

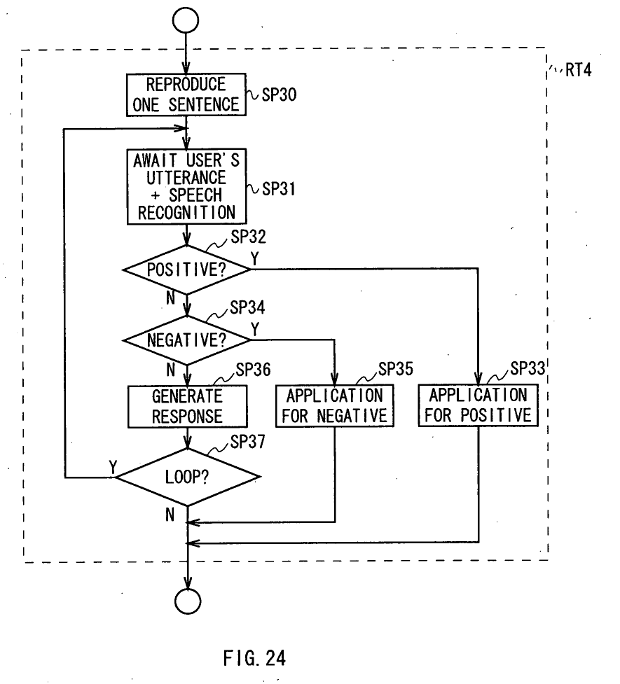

Practically, when in reproducing this second question/answer block BL4, according to a procedure for reproducing second question/answer block RT4 shown in FIG. 24, as to steps SP30-SP36, the scenario reproducing part 62 performs processing similarly to steps SP20-SP26 of the aforementioned procedure for reproducing third block RT3.

In step SP36, the scenario reproducing part 62 requests the response generating part 63 to generate an answering sentence. In this manner, if receiving character string data D3 for the answering sentence generated by the response generating part 63, the scenario reproducing part 62 supplies this to the voice synthesis part 64, and also determines whether or not the answering sentence is loop type.

Specifically, the response generating part 63 is designed so that when in supplying the character string data D3 for the answering sentence generated by receiving the request from the scenario reproducing part 62 to the scenario reproducing part 62, in the case where the answering sentence is a question sentence or the like that can be answered by the user by “yes” or “no”, it adds attribute information showing that the answering sentence is a first loop type to the above character string data D3, in the case where the answering sentence is a request sentence or the like that cannot be answered by the user by “yes” or “no”, it adds attribute information showing that the answering sentence is a second group type to the above character string data D3, and in the case where the answering sentence is a declarative sentence that is unnecessary to be responded by the user, it adds attribute information showing that the answering sentence is a noloop type to the above character string data D3.

In this manner, when in reproducing this second question/answer block BL4, in step SP36 of the procedure for reproducing second question/answer block RT4, based on the attribute information on the above answering sentence supplied with the character string data D3 for the answering sentence from the response generating part 63, if the answering sentence is the first loop type, the scenario reproducing part 62 returns to step SP31, and after that, repeats the processing of steps SP31-SP36 until an affirmative result is obtained in step SP37.

If an affirmative result is soon obtained in step SP37 by that the response generating part 63 generated the noloop type of answering sentence, the scenario reproducing part 62 stops the reproducing processing of this second question/answer block BL4, and then proceeds to the reproducing processing of a block BL following this.

(2-2-6) Third Question/Answer Block BL5 (Loop Type 2)

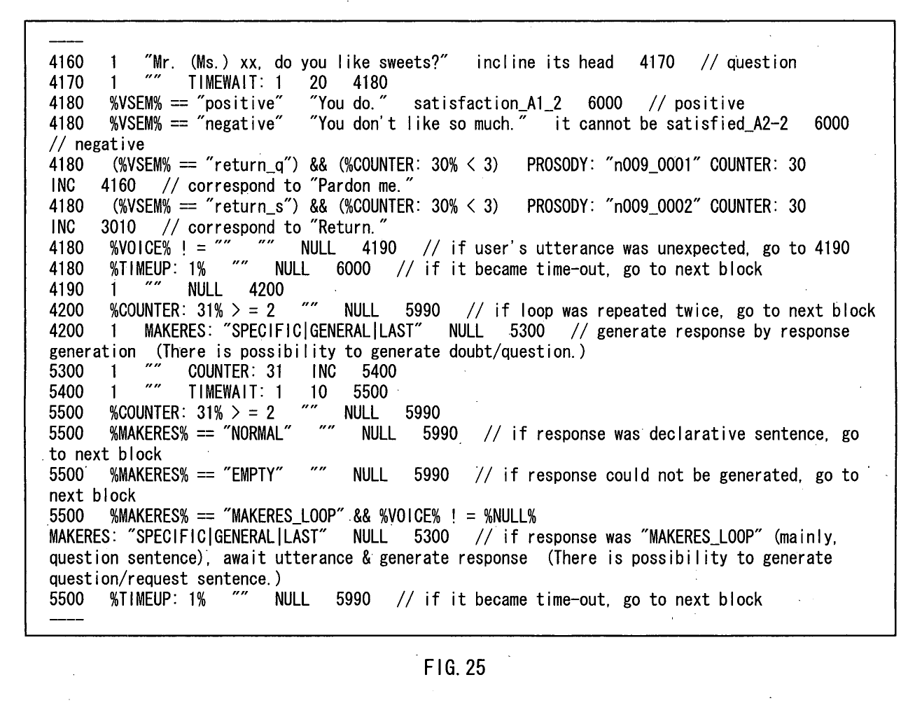

The third question/answer block BL5 is a block BL that will be used to prevent that a dialogue becomes unnatural, by considering the contents of an answering sentence to be generated in the response generating part 63 in the case where the user's response to a question or the like was neither positive nor negative, similarly to the second question/answer block BL4, and it has a program configuration shown in FIG. 25, for example.

In this case, in this third question/answer block BL5, it is designed so that when the response generating part 63 generates an answering sentence, in the case where as the above answering sentence, the sentence which cannot be answered by the user by “yes” or “ino”, for example, a request sentence such as “Try to say the same thing in different words.” or a question sentence such as “How do you think about that?” was generated, the user's response to that can be accepted and the robot 1 can respond to this.

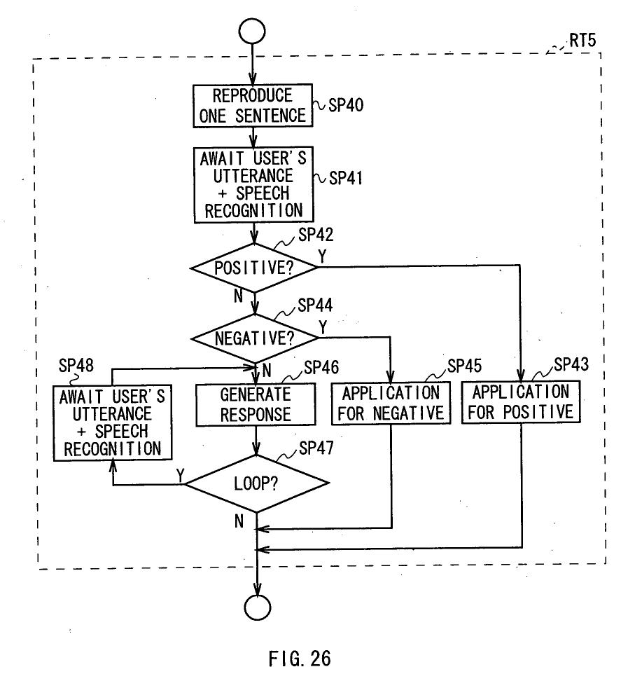

Practically, when in reproducing this third question/answer block BL5, according to a procedure for reproducing third question/answer block RT5 shown in FIG. 26, as to steps SP40-SP46, the scenario reproducing part 62 performs processing similarly to steps SP20-SP26 of the aforementioned procedure for reproducing first question/answer block RT3 (FIG. 15).

Next, the scenario reproducing part 62 proceeds to step SP47 to determine whether or not the answering sentence based on the character string data D3 is the aforementioned second loop type, based on the attribute information added to the character string data D3 supplied from the response generating part 63.

In the case where that response sentence is the second loop type, the scenario reproducing part 62 returns to step SP46, and after that, repeats the processing of steps SP46-SP48-SP46 until a negative result is obtained in step SP47.

If positive result is soon obtained in step SP47 by that the response generating part 63 generated the noloop type of answering sentence, the scenario reproducing part 62 stops the reproducing processing of this third question/answer block BL5, and then proceeds to the reproducing processing of a block BL following this.

(2-2-7) Fourth Question/Answer Block BL6 (Loop Type 3)

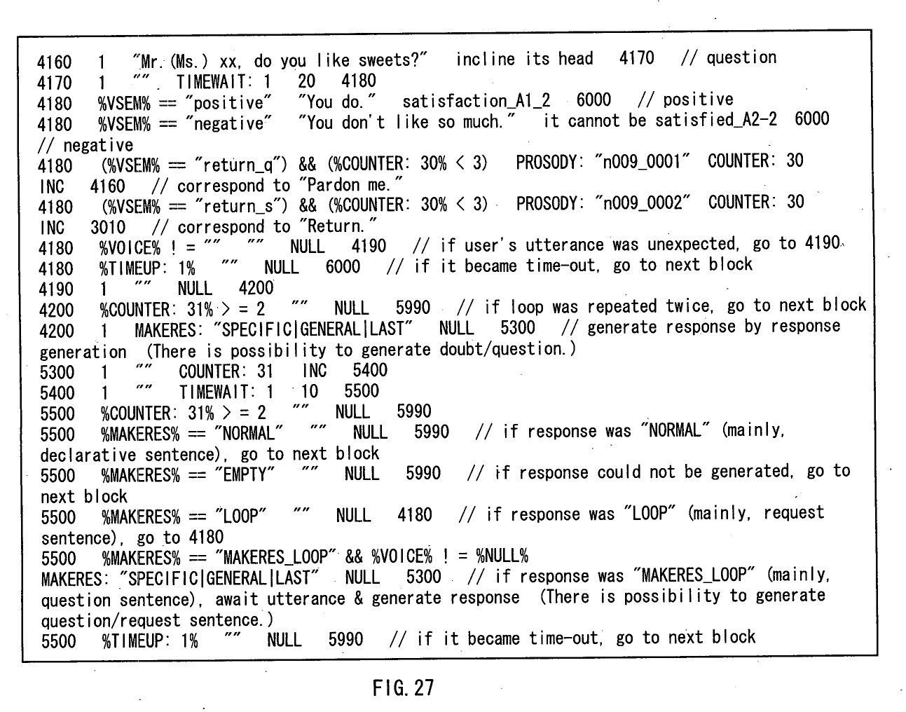

The fourth question/answer block BL6 is a block that will be used to prevent that a dialogue becomes unnatural, by considering the contents of an answering sentence to be generated in the response generating part 63 in the case where the user's response to a question or the like was neither positive nor negative, similarly to the second and the third question/answer blocks BL4 and BL5, and it has a program configuration shown in FIG. 27, for example.

In this case, in this fourth question/answer block BL6, it is designed so that the scenario reproducing part 62 can cope with both cases that the answering sentence generated by the response generating part 63 is the aforementioned first loop type and that it is the second loop type.

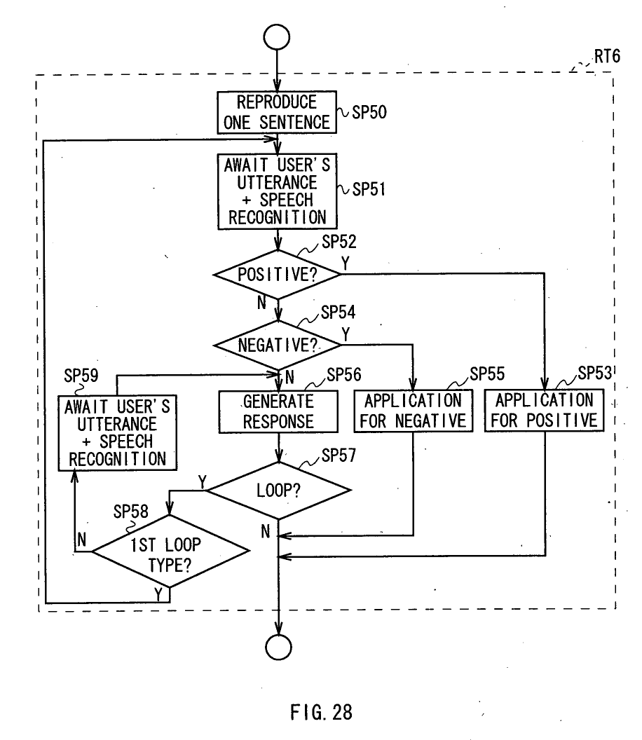

Practically, when in reproducing this fourth question/answer block BL6, according to a procedure for reproducing fourth question/answer block RT6 shown in FIG. 28, as to steps SP50-SP56, the scenario reproducing part 62 performs processing similarly to steps SP20-SP26 of the aforementioned procedure for reproducing first question/answer block RT3 (FIG. 15).

After the processing of step SP56, the scenario reproducing part 62 proceeds to step SP57 to determine whether or not the generated answering sentence is either the aforementioned first or second loop type, based on the attribute information added to the character string data D3 supplied from the response generating part 63.

In the case where that answering sentence is either of the first and the second loop types, the scenario reproducing part 62 proceeds to step SP58 to determine whether or not the above answering sentence is the first loop type.

If an affirmative result is obtained in this step SP58, the scenario reproducing part 62 returns to step SP51. If a negative result is obtained in step SP58, the scenario reproducing part 62 proceeds to step SP59 to await the user's response. If a response was made soon, the scenario reproducing part 62 recognizes this based on the character string data D1 from the speech recognition part 60, and then returns to step SP56. After that, the scenario reproducing part 62 repeats the processing of steps SP51-SP59 until a negative result is obtained in step SP57.

If a positive result is soon obtained in step SP57 by that the response generating part 63 generated the noloop type of answering sentence, the scenario reproducing part 62 stops the reproducing processing of this fourth question/answer block BL6, and then proceeds to the reproducing processing of a block BL following this.

(2-2-8) First Dialogue Block BL7 (No Loop)

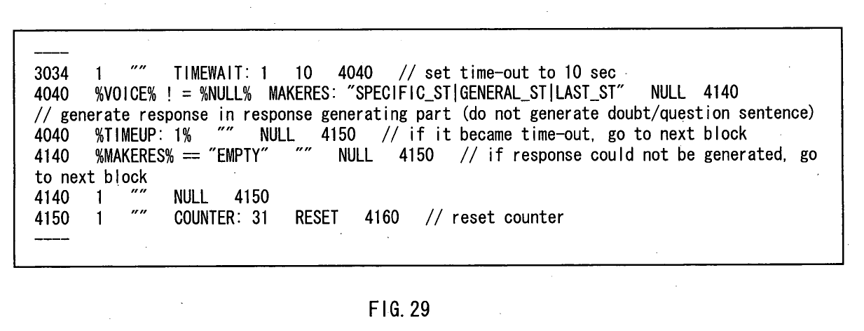

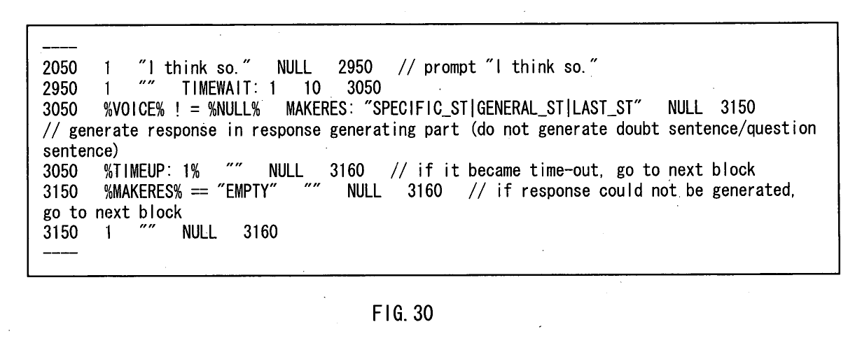

The first dialogue block BL7 is a block BL that will be used to add an opportunity to make the user give utterance, and it has a program configuration shown in FIGS. 29 and 30, for example. Note that, FIG. 29 shows an example of the program configuration in the case where there is a prompt, and FIG. 30 shows an example of the program configuration in the case where there is no prompt.

For example, by placing this first dialogue block BL7 immediately after the one sentence scenario block BL1 described above with FIGS. 9 and 10, the turns of dialogue can be increased: it can give the user a feeling of “making a dialogue.”

Furthermore, for example, by that the robot 1 reproduces a word (prompt) such as “I think so.”, “Is it wrong?” and “What do you think?”, the user becomes easy to give utterance. Therefore, in this first dialogue block BL7, it is designed so that the scenario reproducing part 62 reproduces one sentence (prompt) shown in Fig., before awaiting the user's utterance. However, because this one sentence sometimes becomes unnecessary depending upon the contents of utterance by the robot 1 in the block BL reproduced immediately before, it is designed to be omittable.

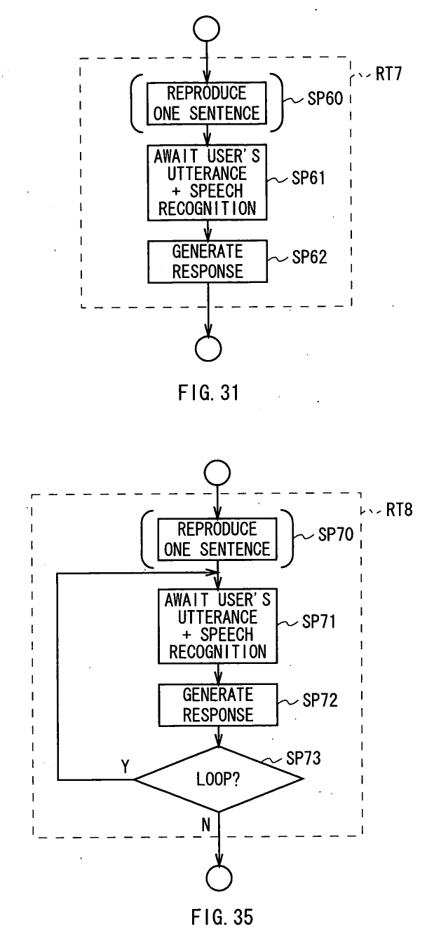

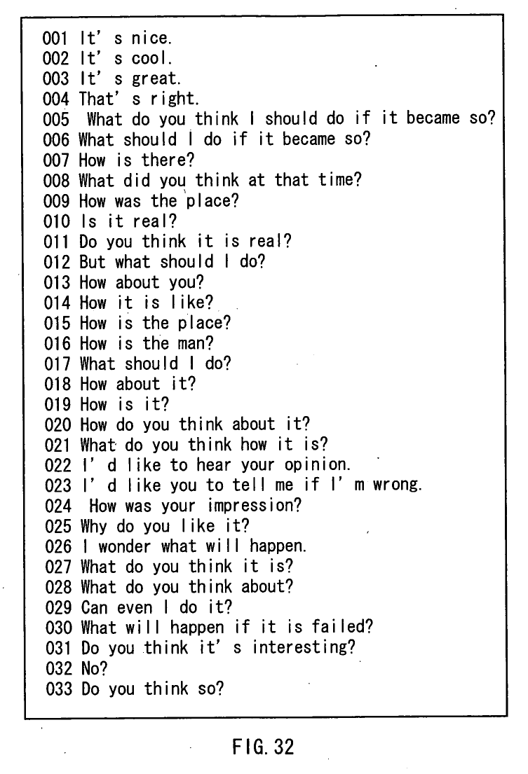

Practically, when in reproducing this first dialogue block BL7, according to a procedure for reproducing first dialogue block RT7 shown in FIG. 31, first, in step SP60, the scenario reproducing part 62 reproduces omittable one prompt, for example, shown in Fig., that has been provided by the block maker as the occasion demands, and then in the next step SP61, the scenario reproducing part 62 awaits the user's utterance to that.

If the scenario reproducing part 62 soon recognizes that the user uttered based on the character string data D1 from the speech recognition part 60, it proceeds to step SP62 to supply the answering sentence generation request COM to the response generating part 63, with the above character string data D1.

As a result, an answering sentence is generated in the response generating part 63 based on these character string data D1 and answering sentence generation request COM, and its character string data D3 is supplied to the voice synthesis part 64 via the scenario reproducing part 62.

Then, the scenario reproducing part 62 stops the reproducing processing of this first dialogue block BL7, and then proceeds to the reproducing processing of a block BL following this.

(2-2-9) Second Dialogue Block BL8 (Loop)

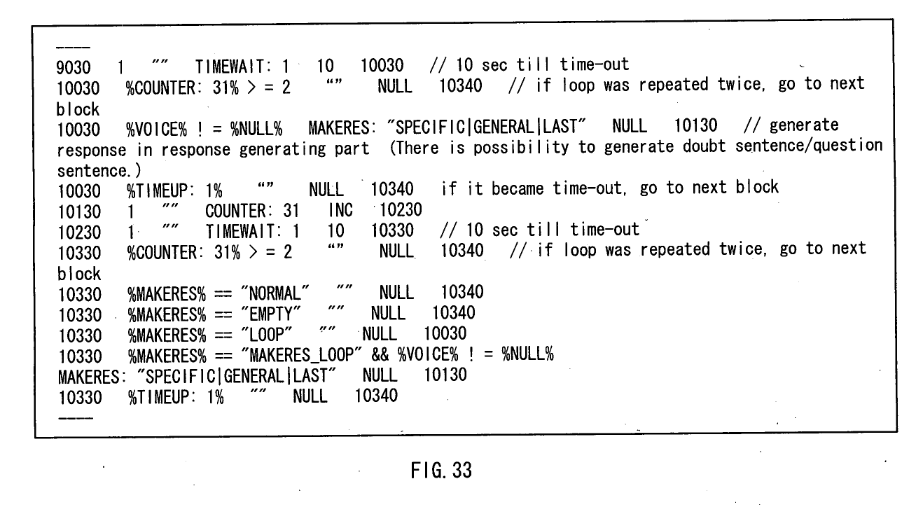

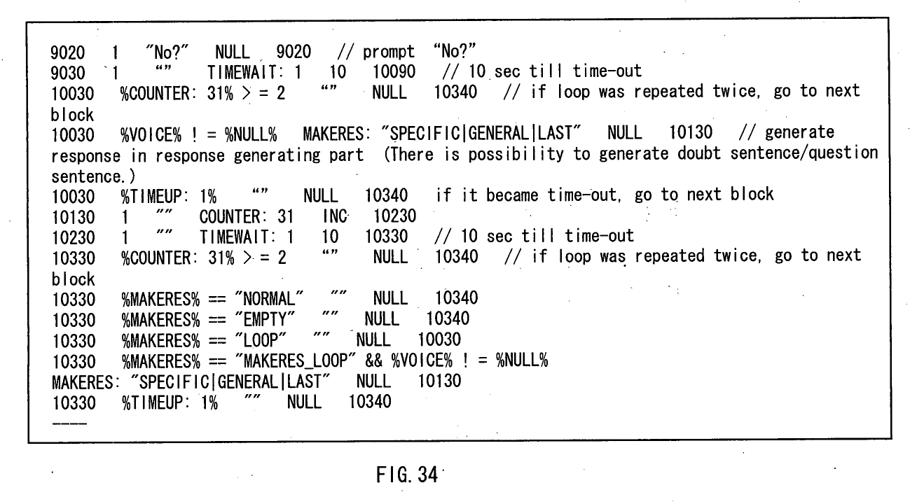

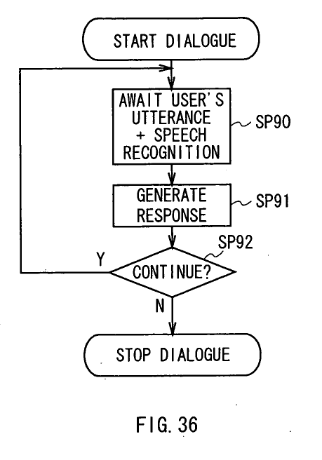

The second dialogue block BL8 is a block BL that will be used to add an opportunity to make the user give utterance same as the first dialogue block BL7, and it has a program configuration shown in FIG. 33 or 34, for example. Note that, FIG. 33 shows an example of the program configuration in the case where there is a prompt, and FIG. 34 shows an example of the program configuration in the case where there is no prompt.

This second dialogue block BL8 is effective in the case where there is a possibility that in step SP62 of the procedure for reproducing first dialogue block RT7 described above with FIG. 31., the response generating part 63 generates a question sentence or a request sentence as the answering sentence.

Practically, when in reproducing this second dialogue block BL8, according to a procedure for reproducing eighth block RT8 shown in FIG. 35, as to steps SP70-SP72, the scenario reproducing part 62 performs processing similarly to steps SP60-SP62 of the aforementioned procedure for reproducing first dialogue block RT7 (FIG. 31).

In the next step SP703, the scenario reproducing part 62 determines whether or not the answering sentence is the second loop type, based on the aforementioned attribute information added to the character string data D3 supplied from the response generating part 63.

If an affirmative result is obtained in this step SP73, the scenario reproducing part 62 returns to step SP71, and after that, it repeats the loop of steps SP71-SP73 until a negative result is obtained in step SP73.

If a negative result is soon obtained in step SP73 by that the response generating part 63 generated the no-loop type of answering sentence, the scenario reproducing part 62 stops the reproducing processing of this second dialogue block BL8, and then proceeds to the reproducing processing of a block BL following this.

(3) Method for Making Scenario 61

Next, a method for making a scenario 61 by use of the above first-ninth blocks BL1-BL9 will be described.

As the method for making the scenario 61 by using the aforementioned various configurations of blocks BL1-BL9, there are a first scenario making method in which a scenario 61 will be made completely from the beginning, and a second scenario making method in which a new scenario 61 will be made by adding a modification to the existing scenario 61.

In this case, in the first scenario making method, as described above with FIG. 7, a desired scenario 61 can be made by aligning an arbitrary number of eight kinds of various blocks BL1-BL8 in arbitrary order in series, and respectively providing a necessary sentence in each block BL according to the preference of the person who makes the scenarios.

Furthermore, in the second scenario making method, a new scenario 61 can be easily made, on the existing scenario 61 composed of the aforementioned one sentence scenario block BL1 and question block BL2,

[1] by changing the question block BL2 with one of the first-the fourth question/answer blocks BL3-BL6 (it may be the first or the second dialogue block BL7 or BL8, depending on the contents of the preceding and the following blocks BL).

[2] by inserting one or more number of the first or the second dialogue block BL7 or BL8 (it may be the one sentence scenario block BL1, the question block BL2 or the first-the fourth question/answer blocks BL3-BL6, depending on the contents of the preceding and the following blocks BL) immediately after the one sentence scenario block BL1.

(4) Operation and Effects of this Embodiment

According to the above structure, in this robot 1, under the control of the scenario reproducing part 62, in the normal state, “dialogue having scenario” is performed with the user according to the scenario 61, on the other hand, in the case where the user gave an unexpected response or the like in the scenario 61, “dialogue having no scenario” is performed by an answering sentence generated in the response generating part 63.

Accordingly, in this robot 1, even if the user gave an unexpected response in the scenario 61, a suitable response can be returned to this. It can effectively prevent that the story after this becomes unnatural.

Furthermore, in this robot 1, the scenario 61 can be made by aligning an arbitrary number of plural kinds of blocks BL in which the action of the robot 1 for one turn in a dialogue including one sentence to be uttered by the robot 1 has been provided, in arbitrary order. Therefore, making it is easy, and also interesting scenarios can be easily made with less process by using the existing scenario 61.

According to the above structure, under the control of the scenario reproducing part 62, in the normal state, “dialogue having scenario” is performed with the user according to the scenario 61, on the other hand, in the case where the user gave a response unexpected in the scenario 61 or the like, “dialogue having no scenario” is performed by an answering sentence generated in the response generating part 63. Therefore, it can prevent that the dialogue with the user becomes unnatural, and at the same time, it can give the above user a feeling of “making a dialogue.” Thus, a robot that can make a natural dialogue with the user can be realized.

(5) Other Embodiments

In the aforementioned embodiment, it has dealt with the case where this invention is applied to the robot 1 formed as FIGS. 1-5. However, the present invention is not only limited to this but also can be widely applied to robot apparatuses having various configuration other than that, various dialogue systems for making a dialogue with human beings other than that in other than robot apparatuses, etc.

In the aforementioned embodiments, it has dealt with the case where as blocks BL forming the scenario 61, the aforementioned eight types are prepared. However, the present invention is not only limited to this but also the scenario 61 may be made by a block having a configuration other than these eight types, or the scenario 61 may be made by preparing another type of block in addition to these eight types.

In the aforementioned embodiments, it has dealt with the case where the single response generating part 63 is used. However, the present invention is not only limited to this but also for example dedicated response generating parts may be provided by respectively corresponding to the steps for requesting the response generating part 63 to generate an answering sentence in the third-the eighth blocks BL3-BL8 (steps SP26, SP36, SP46, SP56, SP62 and SP72). Furthermore, two types of them, a response generating part “which does not generate a question sentence and a request sentence” and a response generating part “that there is a possibility to generate a question and a request sentence” may be prepared, and they may be selectively used depending on the situation.

In the aforementioned embodiments, it has dealt with the case where in the second-the sixth blocks BL2-BL6, the steps for determining positive or negative on the user's response (steps SP12, SP14, SP22, SP24, SP32, SP34, SP42, SP44, SP52 and SP54) are provided. However, the present invention is not only limited to this but also the step for matching with another word may be provided instead of them.

Concretely, for example, it also can be designed so that the robot 1 asks the user a question such as “what prefecture did you born?”, and determines a prefecture corresponding to the speech recognition result on the user's answer to this.

In the aforementioned embodiments, it has dealt with the case where the number of times of the loop in the fourth-the sixth and the eighth blocks BL4-BL6 and BL8 (steps SP37, SP47, SP57 and SP73) are set to unlimited. However, the present invention is not only limited to this but also a counter for counting the number of times of the loop may be provided to limit the number of times of the loop based on the counted number of the above counter.

In the aforementioned embodiments, it has dealt with the case where the awaiting time to await the user's utterance is set to unlimited (for example, step SP11 in the Procedure for reproducing question block RT2). However, the present invention is not only limited to this but also the above awaiting time may be limited. For instance, it may be designed so that if the user did not utter in ten seconds after the robot 1 uttered, a response for time-out previously prepared is reproduced and it proceeds to the reproducing processing of the next block BL.

In the aforementioned embodiments, it has dealt with the case where the scenario 61 is formed by aligning the blocks BL in series. However, the present invention is not only limited to this but also branches may be provided in the scenario 61 by arranging blocks BL in parallel or the like.

In the aforementioned embodiments, it has dealt with the case where the robot 1 appears only voice in a dialogue with the user. However, the present invention is not only limited to this but also a motion (action) may be appeared in addition to voice.

In the aforementioned embodiments, it has dealt with the case where requests from the user are not accepted. However, the present invention is not only limited to this but also the scenario 61 may be made so that requests from the user such as “Stop.” and “I beg your pardon.” can be accepted.

In the aforementioned embodiments, it has dealt with the case where the speech recognition part 60 serving as speech recognition means for performing speech recognition on the user's utterance, the scenario reproducing part 62 serving as dialogue control means for controlling a dialogue with the user according to the scenario 61 previously given, based on the speech recognition result by the speech recognition part 60, the response generating part 63 serving as response generating means for generating an answering sentence according to the contents of the user's utterance, responding to a request from the scenario reproducing part 62, and the voice synthesis part 64 serving as voice synthesis means for performing voice synthesis processing to one sentence of the scenario 61 reproduced by the scenario reproducing part 62 or the answering sentence generated by the response generating part 63 are combined as shown in FIG. 6. However, the present invention is not only limited to this but also for example character string data D3 supplied from the response generating part 63 may be directly supplied to the voice synthesis part 64. As the combination of these speech recognition part 60, scenario reproducing part 62, response generating part 63 and voice synthesis part 64, various combinations other than this can be widely applied.

According to the present invention as described above, in a voice dialogue system, dialogue control means for controlling a dialogue with the user according to a scenario previously given, based on the speech recognition result by speech recognition means for performing speech recognition on the user's utterance, and response generating means for generating an answering sentence according to the contents of the user's utterance, responding to a request from the dialogue control means are provided. The dialogue control means requests the response generating means to generate an answering sentence as the occasion demands, based on the contents of the user's utterance. Thereby, it can be prevented that the dialogue with the user becomes unnatural, and at the same time, a feeling of “making a dialogue” can be given to the above user. Thus, a voice dialogue system capable of making a natural dialogue with the user can be realized.

According to the present invention, a first step for performing speech recognition on the user's utterance, a second step for controlling a dialogue with the user according to a scenario previously given based on the speech recognition result, and generating an answering sentence according to the contents of the user's utterance as the occasion demands, and a third step for performing voice synthesis processing to one sentence of the reproduced scenario or the generated answering sentence are provided. In the second step, an answering sentence according to the contents of the user's utterance is generated as the occasion demands, based on the contents of the user's utterance, so that it can be prevented that the dialogue with the user becomes unnatural, and at the same time, a feeling of “making a dialogue” can be given to the above user. Thus, a voice dialogue method in which a natural dialogue can be performed with the user can be realized.

Furthermore, according to the present invention, in a robot apparatus, dialogue control means for controlling a dialogue with the user according to a scenario previously given, based on speech recognition result by speech recognition means for performing speech recognition on the user's utterance, and response generating means for generating an answering sentence according to the contents of the user's utterance, responding to a request from the dialogue control means are provided. The dialogue control means requests the response generating means to generate an answering sentence as the occasion demands, based on the contents of the user's utterance. Thereby, it can be prevented that the dialogue with the user becomes unnatural, and at the same time, a feeling of “making a dialogue” can be given to the above user. Thus, a robot apparatus capable of making a natural dialogue with the user can be realized.

### INDUSTRIAL UTILIZATION

The present invention is widely applicable to various apparatuses having a voice dialogue function such as personal computers in addition to entertainment robots.

1. A voice dialogue system comprising:
speech recognition means for performing speech recognition on the user's utterance;
dialogue control means for controlling a dialogue with said user according to a scenario previously given, based on the speech recognition result by said speech recognition means;
response generating means for generating an answering sentence corresponding to the contents of said user's utterance, responding to a request from said dialogue control means; and
speech synthesis means for performing speech synthesis processing to one sentence in said scenario reproduced by said dialogue control means or said answering sentence generated by
said response generating means; and
said voice dialogue system wherein, said dialogue control means requests said response generating means to generate said answering sentence as the occasion demands, based on the contents of said user's utterance.

2. The voice dialogue system according to claim 1, wherein;
said dialogue control means controls said dialogue with said user based on the attribute of said answering sentence generated by said response generating means.

3. The voice dialogue system according to claim 1, wherein;
said scenario is made by combining an arbitrary number of plural types of blocks in a respectively predetermined format providing for one turn of a dialogue with said user, in an arbitrary order.

4. The voice dialogue system according to claim 3, comprising;
as one of said blocks, a first block having,
a first reproducing step for reproducing said one sentence to urge said user to utterance,
a first utterance await and recognition step for awaiting said user's utterance after the above first reproducing step, and when said user uttered, recognizing the contents of the above utterance, and
a second reproducing step, following said first utterance await and recognition step, for reproducing corresponding one sentence previously provided, depending on whether the contents of the above utterance is positive or negative.

5. The voice dialogue system according to claim 4, comprising;
as one of said blocks, a second block having a first generation of answering sentence request step, when the contents of said user's utterance recognized in said first utterance await and recognition step is neither said positive nor said negative, for requesting said response generating means to generate said answering sentence corresponding to said contents of said user's utterance.

6. The voice dialogue system according to claim 5, comprising;
as one of said blocks, a third block having a first loop in which if the attribute of said answering sentence, that was generated by said response generating part responding to said request in said first generation of answering sentence request step, is the first loop type, it returns to said first utterance await and recognition step.

7. The voice dialogue system according to claim 5, comprising;
as one of said blocks, a fourth block having a second loop in which if the attribute of said answering sentence, that was generated by said response generating part responding to said request in said first generation of answering sentence request step, is the second loop type, it awaits said user's utterance, and when said user uttered, it recognizes the contents of the above utterance, and then returns to said generation of answering sentence request step.

8. The voice dialogue system according to claim 5, comprising;
as one of said blocks, a fifth block having,
determination step for determining the attribute of said answering sentence, that was generated by said response generating part responding to said request in said first generation of answering sentence request step,
a first loop in which if said attribute of said, answering sentence determined in the above determination step is the first loop type, it returns to said first utterance await and recognition step, and
a second loop in which if said attribute of said answering sentence determined in the above determination step is the second loop type, it awaits said user's utterance, and when said user uttered, it recognizes the contents of the above utterance, and then returns to said generation of answering sentence request step.

9. The voice dialogue system according to claim 3, comprising;
as one of said blocks, a sixth block having,
a second reproducing step for reproducing said one sentence omittable in said scenario if needed,
a second utterance await and recognition step, for awaiting said user's utterance after said second reproducing step, and when said user uttered, for recognizing the contents of the above utterance, and
a second generation of answering sentence request step, following said second utterance await and recognition step, for requesting said response generating means to generate said answering sentence corresponding to said contents of said user's utterance.

10. The voice dialogue system according to claim 9, comprising;
as one of said blocks, a seventh block having a third loop in which if the attribute of said answering sentence, that was generated by said response generating part responding to said request in said second generation of answering sentence request step, is the third loop type, it returns to said second utterance await and recognition step.

11. A voice dialogue method comprising:
a first step for performing speech recognition on the user's utterance;
a second step for controlling a dialogue with said user according to a scenario previously given, based on the results of said speech recognition, and if needed, generating an answering sentence corresponding to the contents of said user's utterance; and
a third step for performing speech synthesis processing to one sentence in said reproduced scenario or said generated answering sentence; and
said voice dialogue method wherein,
in said second step, said answering sentence corresponding to the contents of said user's utterance is generated as the occasion demands, based on the contents of said user's utterance.

12. The voice dialogue method according to claim 11, wherein;
in said second step, said dialogue with said user is controlled based on the attribute of said generated answering sentence.

13. The voice dialogue method according to claim 11, wherein;
said scenario is made by combining an arbitrary number of plural types of blocks in a respectively predetermined format providing for one turn of a dialogue with said user, in an arbitrary order.

14. The voice dialogue method according to claim 13, comprising;
as one of said blocks, a first block having,
a first reproducing step for reproducing said one sentence to urge said user to utterance,
a first utterance await and recognition step for awaiting said user's utterance after the above first reproducing step, and when said user uttered, recognizing the contents of the above utterance, and
a second reproducing step, following said first utterance await and recognition step, for reproducing corresponding one sentence previously provided, depending on whether the contents of the above utterance is positive or negative.

15. The voice dialogue method according to claim 14, comprising;
as one of said blocks, a second block having a first generation of answering sentence request step, when the contents of said user's utterance recognized in said first utterance await and recognition step is neither said positive nor said negative, for generating said answering sentence corresponding to said contents of said user's utterance.

16. The voice dialogue method according to claim 15, comprising;
as one of said blocks, a third block having a first loop in which if the attribute of said answering sentence generated in said first answering sentence generating step is the first loop type, it returns to said first utterance await and recognition step.

17. The voice dialogue method according to claim 15, comprising;
as one of said blocks, a fourth block having a second loop in which if the attribute of said answering sentence generated in said first answering sentence generating step is the second loop type, it awaits said user's utterance, and when said user uttered, it recognizes the contents of the above utterance, and then returns to said answering sentence generating step.

18. The voice dialogue method according to claim 15, comprising;
as one of said blocks, a fifth block having,
determination step for determining the attribute of said answering sentence generated in said first answering sentence generating step,
a first loop in which if said attribute of said answering sentence determined in the above determination step is the first loop type, it returns to said first utterance await and recognition step, and
a second loop in which if said attribute of said answering sentence determined in the above determination step is the second loop type, it awaits said user's utterance, and when said user uttered, it recognizes the contents of the above utterance, and then returns to said answering sentence generating step.

19. The voice dialogue method according to claim 13, comprising;
as one of said blocks, a sixth block having,
a second reproducing step for reproducing said one sentence omittable in said scenario if needed,
a second utterance await and recognition step, for awaiting said user's utterance after said second reproducing step, and when said user uttered, for recognizing the contents of the above utterance, and
a second answering sentence generating step, following said second utterance await and recognition step, for generating said answering sentence corresponding to said contents of said user's utterance.

20. The voice dialogue method according to claim 19, comprising;
as one of said blocks, a seventh block having a third loop in which if the attribute of said answering sentence generated in said second answering sentence generating step is the third loop type, it returns to said second utterance await and recognition step.

21. A robot apparatus comprising:
speech recognition means for performing speech recognition on the user's utterance;
dialogue control means for controlling a dialogue with said user according to a scenario previously given, based on the speech recognition result by said speech recognition means;
response generating means for generating an answering sentence corresponding to the contents of said user's utterance, responding to a request from said dialogue control means; and
speech synthesis means for performing speech synthesis processing to one sentence in said scenario reproduced by said dialogue control means or said answering sentence generated by
said response generating means; and
said robot apparatus wherein, said dialogue control means requests said response generating means to generate said answering sentence as the occasion demands, based on the contents of said user's utterance.
